(19) United States
(12) Patent Application Publication
(10) Pub. No.: US 2006/0227013 A1
(43) Pub. Date: Oct. 12, 2006

(54) Docking guidance

(76) Inventors: Eric Joseph Harvison, Buckinghamshire (GB); David William Sames, Buckinghamshire (GB)

Correspondence Address: DAVIS & BUJOLD, P.L.L.C., 112 PLEASANT STREET, CONCORD, NH, 03301, US

(21) Appl. No.: 10/552,652

(22) PCT Filed: Apr. 8, 2004
(86) PCT No.: PCT/GB04/01524

§ 371 Date: Dec. 20, 2005

(30) Foreign Application Priority Data
Apr. 9, 2003 (GB) 0308184.1

(51) Int. Cl. G08G 5/00

(52) U.S. Cl. 340/958

(57) ABSTRACT

Docking guidance for an aircraft pilot involves viewing horizontal bars (4) and a vertical bar (5) mounted above the pilot's eye-level a short, distance beyond the docking station. The bars (4, 5), which comprise amber Leeds, are viewed against an array of amber Leeds of a back-plane (7). One row (9) of the array, selected according to aircraft type, is turned ON to form a horizontal datum bar (10) towards which the horizontal bars (4) are seen to close as the aircraft moves onto the docking station. Two columns (8) of green LEDs are included in the array and those below the datum bar (10) of the array are ON to form vertical bars (11). The aircraft is manoeuvred in azimuth to keep the vertical bar (5) between the green bars (11). According to a modification, bars (18) of columns (14) of red LEDs that are obscured from the pilot by baffle-screens (15) when the aircraft is properly aligned, become visible upon deviation from alignment; the screens (15) also act according to the extent of the deviation to obscure the nearest green bar (17) from view.

This application is a national stage completion of PCT/GB2004/001524 filed Apr. 8, 2004 which claims priority from British Application Serial No. 0308184.1 filed Apr. 9, 2003.

### FIELD OF THE INVENTION

This invention relates to methods and apparatus for affording docking guidance for aircraft and other vehicles.

### BACKGROUND OF THE INVENTION

According to one aspect of the present invention there is provided a method for affording guidance in bringing an aircraft or other vehicle to a defined position in a docking station, wherein a horizontal indicator fixed relative to the docking station is viewed along an inclined line of sight from the vehicle against a background that includes a horizontal datum which is spaced at a distance behind the horizontal indicator, manoeuvre of the vehicle towards the docking station reducing visually the vertical separation between the horizontal indicator and the horizontal datum until they are visually aligned with one another when the vehicle is located in said defined position in the docking station.

According to another aspect of the invention there is provided apparatus for affording guidance in bringing an aircraft or other vehicle to a defined position in a docking station, comprising a horizontal indicator fixed relative to the docking station and a horizontal datum spaced at a distance behind the horizontal indicator such that when the horizontal indicator is viewed along an inclined line of sight from the vehicle against a background that includes the horizontal datum, manoeuvre of the vehicle towards the docking station reduces visually the vertical separation between the horizontal indicator and the horizontal datum until they are visually aligned with one another when the vehicle is located in said defined position in the docking station.

### SUMMARY OF THE INVENTION

The method and apparatus of the present invention may be used for affording guidance to the pilot of an aircraft in achieving correct positioning of the aircraft in docking within an aircraft-stand of an airport terminal. In this respect, the method and apparatus may be applied for example to stopping the aircraft in the correct location relative to a passenger bridge of the docking station. The horizontal indicator, especially where an aircraft is involved, will normally be located above eye-level so that the line of sight is inclined upwardly to it.

Furthermore, the method and apparatus of the invention as well as affording guidance in stopping an aircraft appropriately in its docking station may afford guidance in alignment of the aircraft within the station; for example, guidance may be afforded for manoeuvring the aircraft into alignment with the center-line of the aircraft-stand. More especially, and in the more general context, the method and apparatus may involve a vertical indicator located with the horizontal indicator and the background may then include a vertical datum that is spaced at said distance behind the horizontal and vertical indicators such that when the vertical and horizontal indicators are viewed along the inclined line of sight against the vertical and horizontal datums of the background, manoeuvre of the vehicle towards and in alignment with the docking station reduces visually both the vertical separation between the horizontal indicator and the horizontal datum as aforesaid, and the horizontal separation between the vertical indicator and the vertical datum.

### BRIEF DESCRIPTION OF THE DRAWINGS

Methods and indicator-apparatus according to the present invention for affording guidance to the pilot of an aircraft in achieving correct positioning of the aircraft in docking within an aircraft-stand of an airport terminal, will now be described by way of example, with reference to the accompanying drawings, in which:

FIG. 1 is a perspective view of indicator-apparatus according to the invention;

FIGS. 2 to 6 are illustrative of respective indications provided by the indicator-apparatus of FIG. 1 in affording guidance to the pilot of the aircraft during different stages of docking the aircraft;

FIGS. 7 and 8 are, respectively, a front elevation and a plan illustrating an array of a modified form of the indicator-apparatus of FIG. 1; and

FIG. 9 is a view of part of the array of FIGS. 7 and 8.

### DETAILED DESCRIPTION OF THE INVENTION

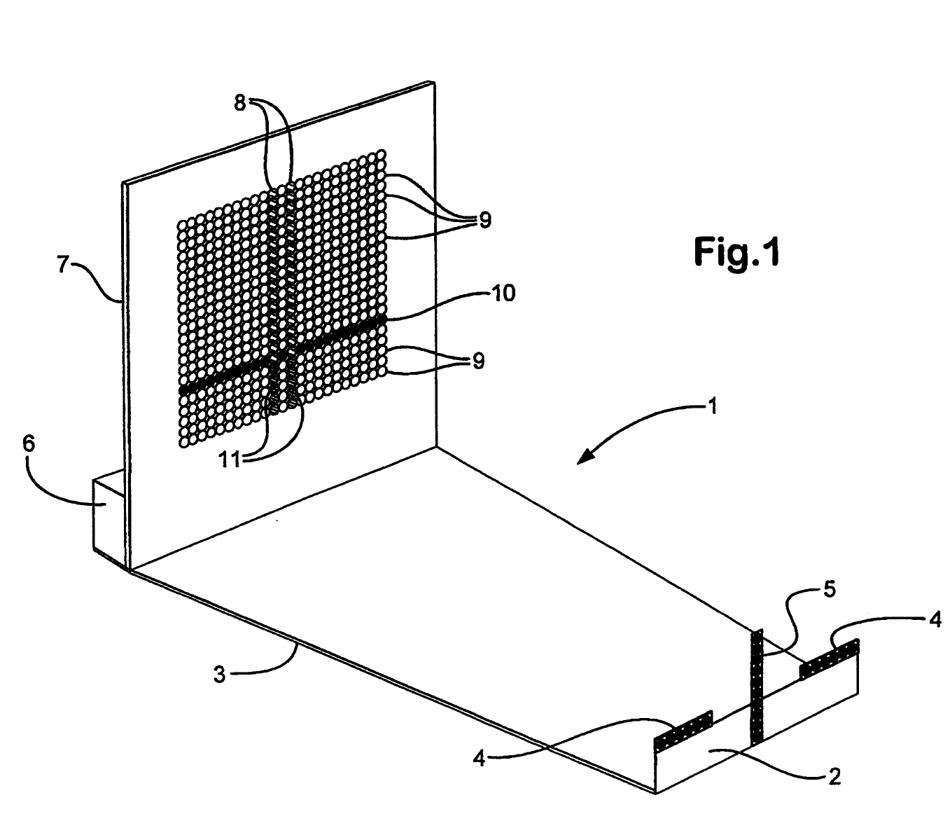

Referring to FIG. 1, the indicator-apparatus 1 is contained within a weatherproof frame (not shown) that is mounted, for example on the airport-terminal building or on a stanchion, a short distance beyond the docking station on the center-line to the aircraft stand. An upstanding front-lip 2 of a horizontal base-panel 3 of the apparatus 1 supports two spaced but horizontally-aligned indicator-bars 4 and a vertical indicator bar 5. The bar 5 extends upwardly through the gap midway between the bars 4 to project above them.

The two indicator-bars 4 and the indicator-bar 5 are formed, respectively, by two rows and a column of amber light-emitting diodes (LEDs) that are energised from an electronic-control box 6. The control box 6 also serves to energise a square array of LEDs mounted in columns and rows on an upstanding back-plane 7 of the base-panel 3 (cable connections from the box 6 to the LEDs are not shown). The array includes two vertical, closely-spaced columns 8 of green LEDs which bisect a multiplicity of horizontal rows 9 of amber LEDs that form the remainder of the array and are mounted one above the other on the back-plane 7. Only one of the rows 9 of amber LEDs is energised from the box 6 to be ON at any one time so as to provide a single horizontal datum-bar 10. Furthermore, only such part of each column 8 of green LEDs that lies below the energised row 9 is energised from the box 6 to be ON so as to establish green indicator-bars 11 extending up to the amber, datum-bar 10. (For the purpose of illustration, amber LEDs are represented in the drawings by circles with centers that are open when the LED is OFF but blocked in when ON, whereas the green LEDs are represented as circles with light cross-hatching when OFF and with heavier cross-hatching when ON.)

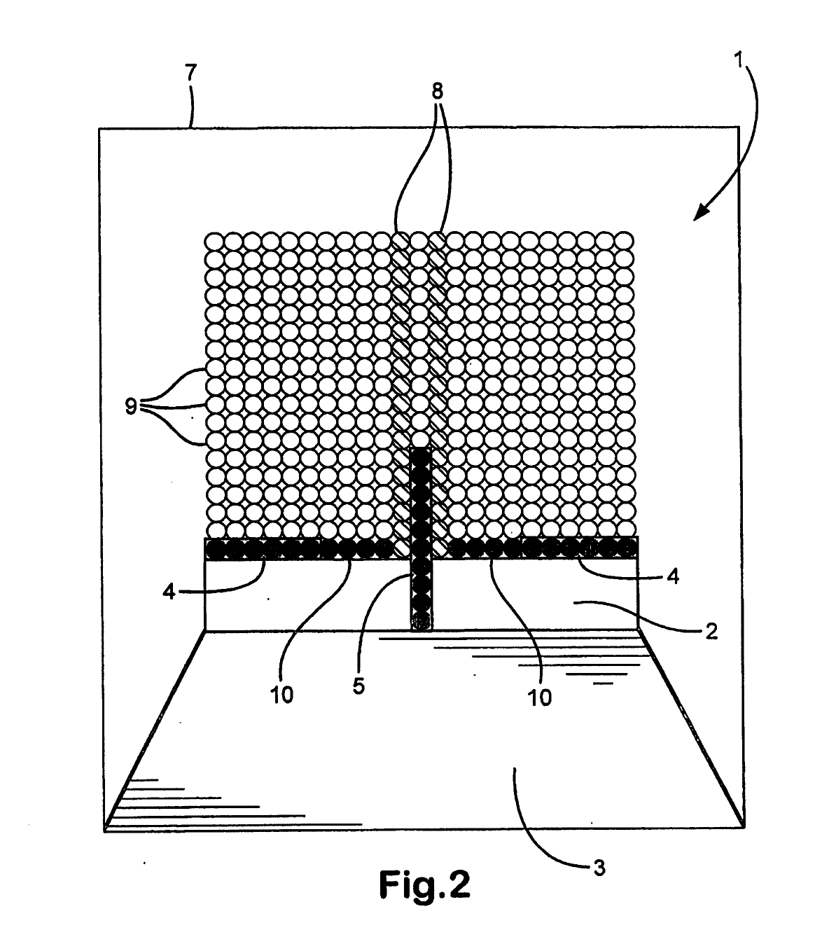

With the indicator-apparatus 1 mounted slightly above the pilot's eye-level, he/she views the amber bars 4 and 5 along an inclined line of sight from the aircraft. The bars 4 and 5 are viewed against the background of the back-plane 7 and the aircraft is manoeuvred with the object of bringing about the visual condition illustrated by FIG. 2. More particularly, the objective is to so align the aircraft that in the pilot's view the vertical bar 5 is located centrally between the green bars 11, and to advance the aircraft until the horizontal bars 4 move upwardly in that view, into alignment with the bar 10. When this objective is achieved, the aircraft has the correct alignment and is in the correct stopping position on its stand for docking. The apparatus 1 affords guidance to the pilot in bringing about the visual condition represented in FIG. 2 and thereby obtaining precision in manoeuvring the aircraft to the docking station.

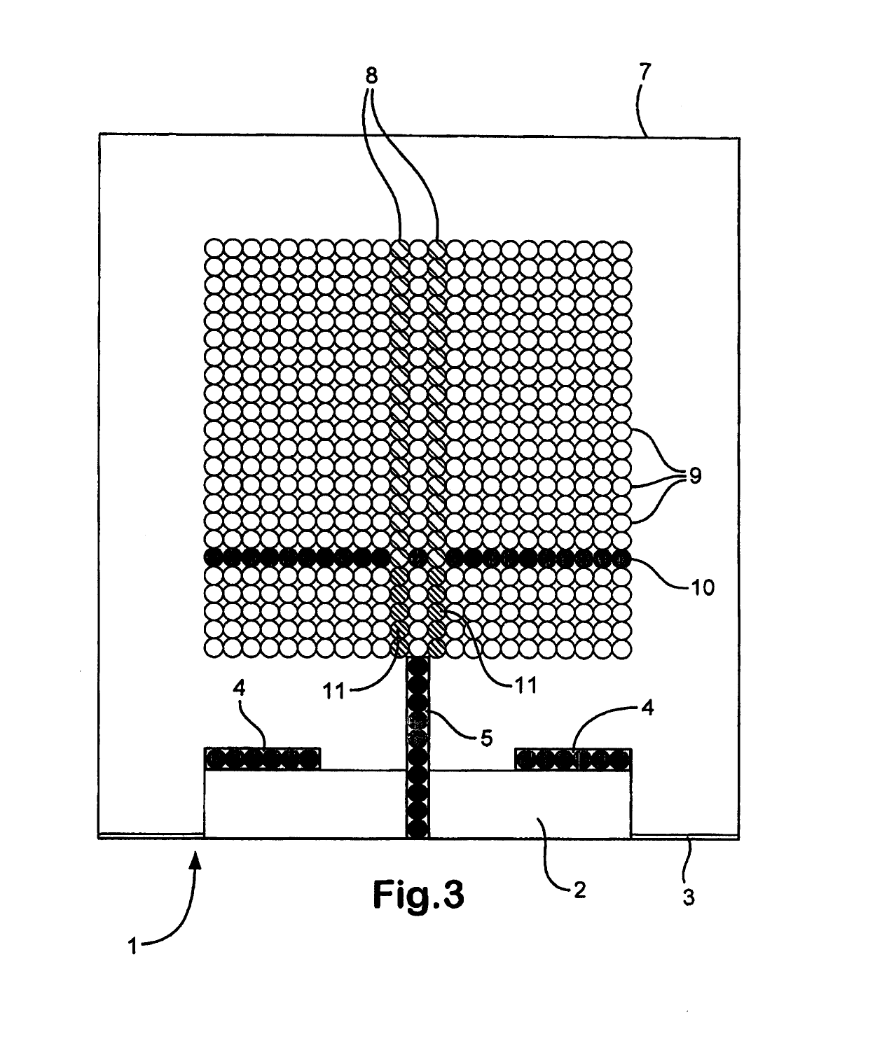

As the aircraft is manoeuvred towards the docking station, the pilot sees, by virtue of change of his/her viewpoint, an apparent movement of the bars 4 and 5 relative to the bars 10 and 11 respectively. Movement of the aircraft in azimuth varies visually the horizontal separation of the vertical bar 5 from the bars 11 such that the bar 5 is seen to lie in the gap between the bars 11 as illustrated in FIG. 3, only when the aircraft is on track along the center-line to the docking station. In the situation illustrated in FIG. 3, the aircraft is on track, but, as indicated by the vertical separation of the bars 4 from the bar 10, is still some distance (for example 20 m) from the appropriate stopping position of the docking station.

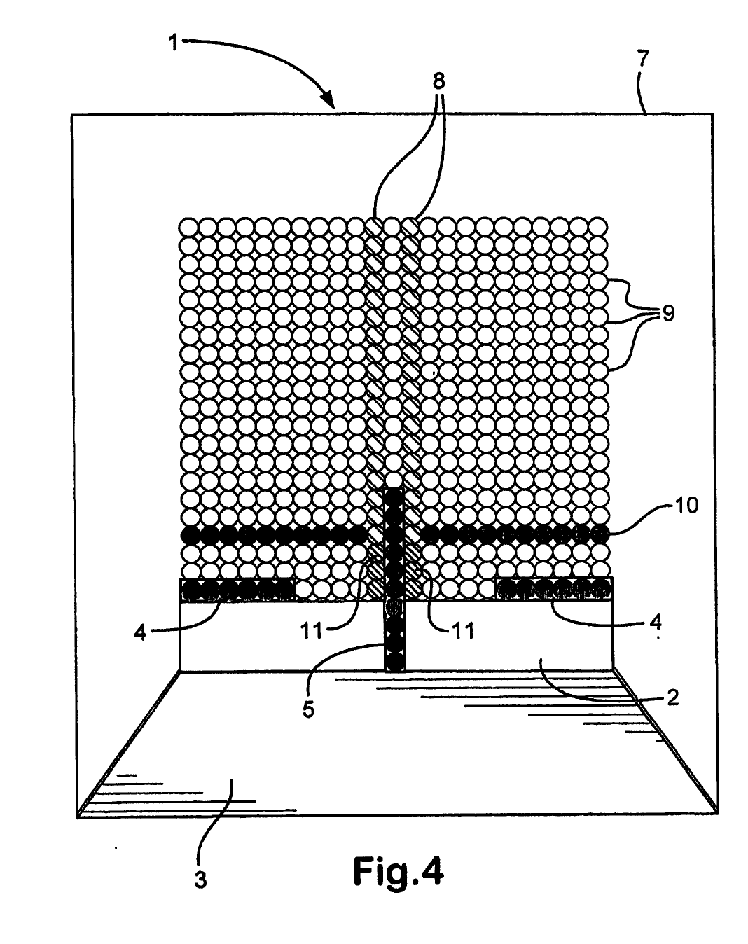

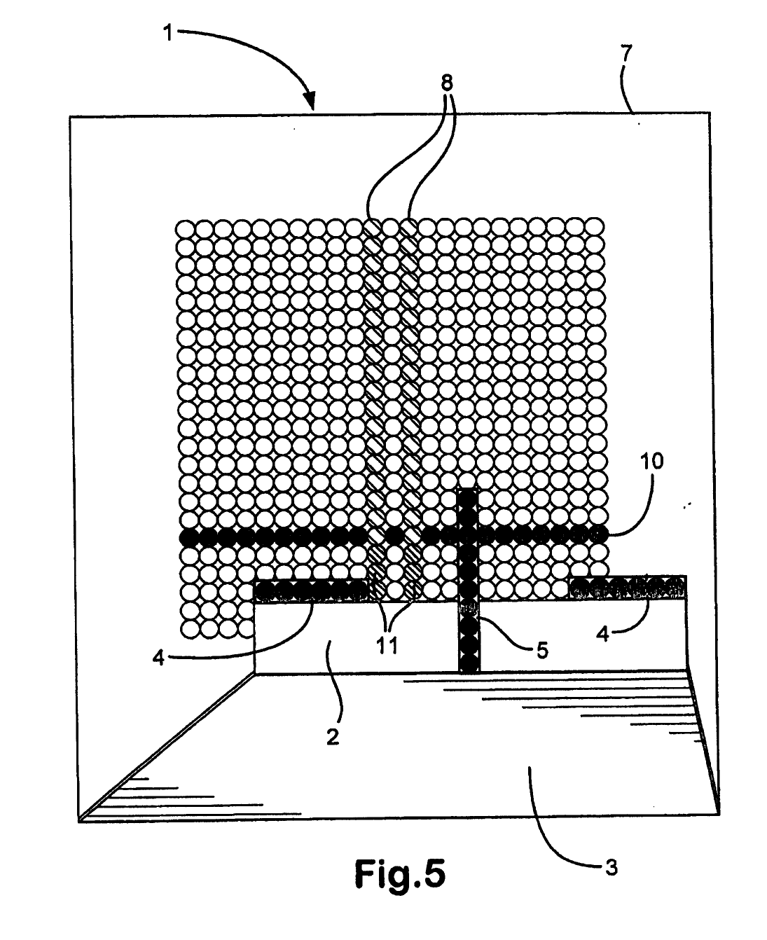

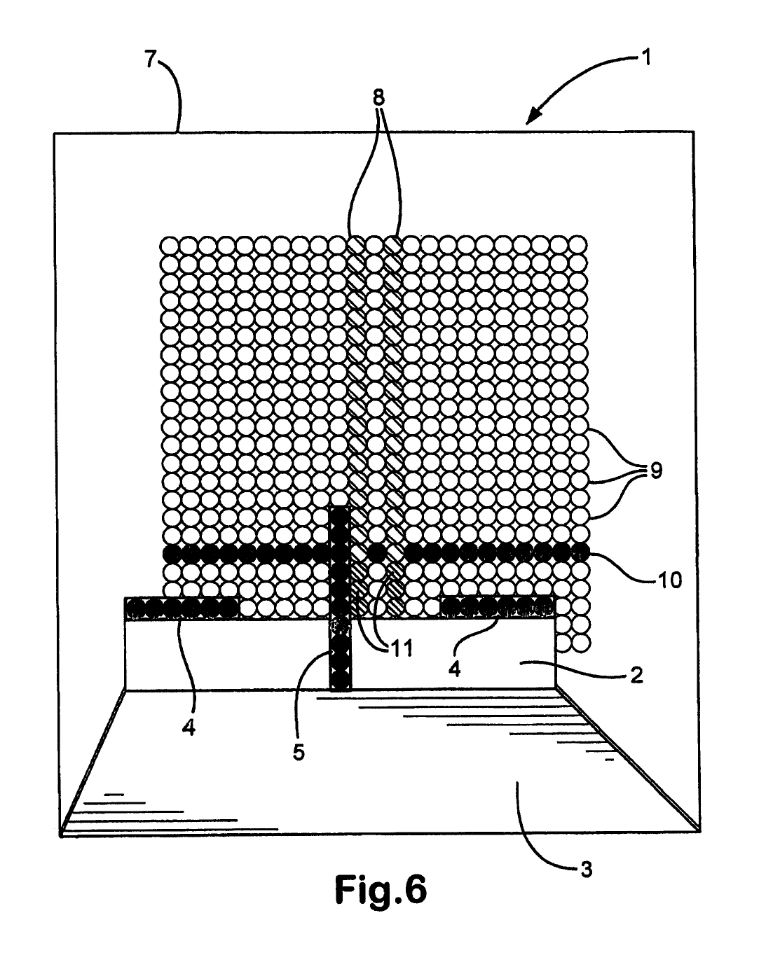

Movement of the aircraft towards the docking station while still maintaining its center-line track, causes the bars 4 to appear by parallax, to ascend towards the bar 10 so that in consequence of the reduction of the distance to the stopping position (for example to 10 m), the pilot's view becomes as illustrated in FIG. 4. If in the same circumstances, the aircraft were to be to the left (for example 0.5 m) of the center-line, the pilot's view would be as illustrated in FIG. 5, whereas if it were half as much to the right (for example by 0.25 m) his/her view would be as illustrated in FIG. 6.

As the aircraft advances towards the docking station, and the bars 4 in consequence appears to ascend progressively towards the bar 10, the pilot steers the aircraft to reduce any visual separation of the bar 5 horizontally from the central location between the bars 11. With any deviation to left or right from the center-line corrected, and the aircraft advanced to bring the bars 4 up onto the bar 10 as illustrated in FIG. 2, the aircraft is brought to a halt. As the aircraft closes on the stopping position, the horizontal panel 3 progressively obscures the green bars 11 so that the pilot is given an analogue display of the rate of closure.

Because manoeuvring of larger aircraft is normally carried out by the captain seated offset to the left of the fore-aft axis of the aircraft, the indicator-apparatus 1 for such aircraft will be mounted with an alignment between the bars 5 and 11 that has the corresponding offset to the left of the center-line to the docking station. Where the second pilot seated offset to the right of the fore-aft axis, may also manoeuvre the aircraft, or both pilots are to be kept informed of progress throughout manoeuvring, this is readily and economically facilitated by addition of a second indicator-apparatus 1 mounted with the appropriate offset to the right of the center-line. The second indicator-apparatus 1 may be energised and controlled from the same control box 6 as the first.

The control box 6 incorporates a facility that varies which of the rows 9 of amber LEDs is energised at any one time in dependence upon the type of aircraft involved in docking. The selection of which row 9 is energised to provide the datum-bar 10 is carried out automatically in accordance with data from aircraft-recognition equipment or the airport ground-control center, or simply manually by ground-crew at the docking station. A table relating aircraft-type to appropriate stopping position within the docking station and taking into account the height of pilot eye-level in the aircraft type, is programmed into the box 6 together with relationships between the individual rows 9 and the stopping positions they realise according to eye-level height. From the table and these relationships, the box 6 determines which of the rows 9, and consequently which of the green LEDs of the columns 8, are to be energised to provide the appropriate horizontal datum-bar 10 and the vertical bars 11 to it, for the aircraft concerned. The brilliance of the energised LEDs providing the bar 10, and also of the LEDs providing the other bars 4, 5 and 11, is controlled from the box 6 according to weather and daylight conditions.

The apparatus of the present invention has the particular advantage that it avoids the use of complex optical systems and electronic equipment, and that it has reliability and economic benefits not enjoyed by prior proposals for docking guidance. Moreover, guidance is provided positively in a clear representational manner directly in front of the aircraft and without the need for the pilot or pilots to turn their heads away from the forward view to the docking station.

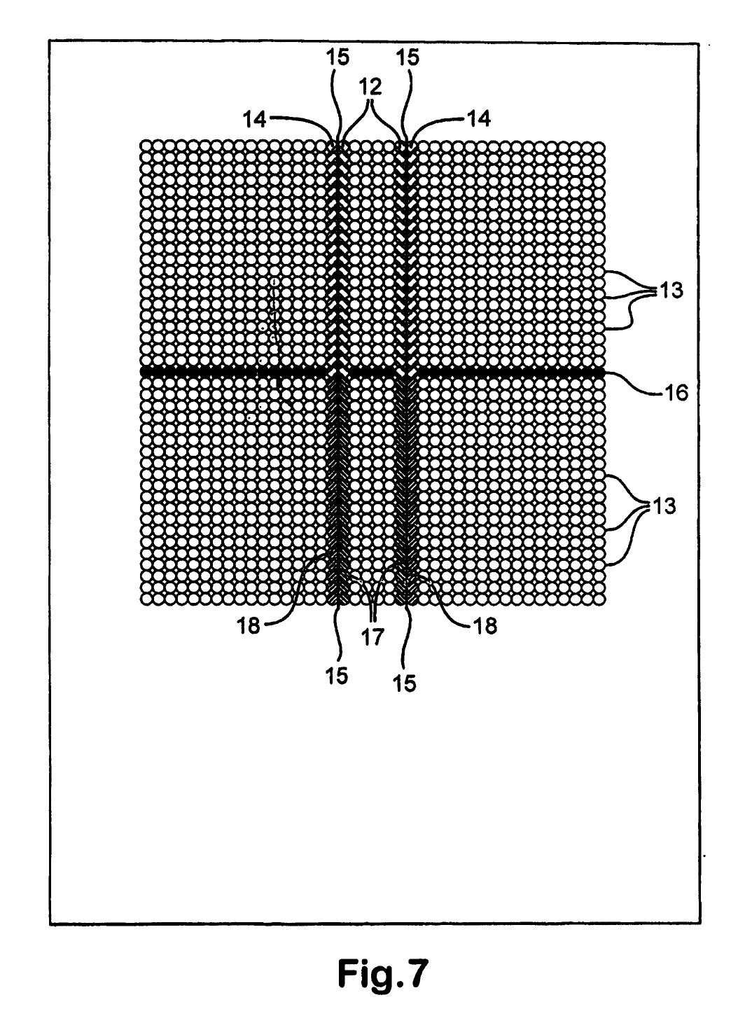

The indicator-apparatus may be modified to assist further with alignment of the aircraft for docking. The modification in this respect is confined to the LED array of the apparatus, and will now be described with reference to FIGS. 7 to 9.

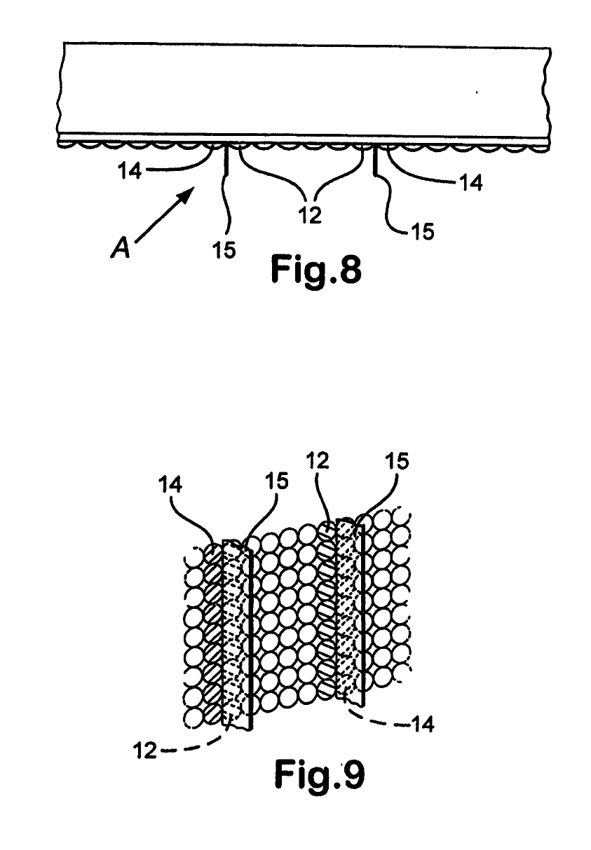

Referring to FIGS. 7 and 8, the modified LED array, like that of the apparatus 1 described above, includes two spaced columns 12 of green LEDs that extend vertically through horizontal rows 13 of amber LEDs, but the spacing between the columns 12 is larger. More particularly, the columns 12, rather than being spaced from one another in each row 13 by a single amber LED, are spaced from one another by four amber LEDs of the row. Also, each column 12 of green LEDs has an adjoining, vertical column 14 of red LEDs from which it is divided by a vertical forwardly-projecting baffle-screen 15 such that the two columns 12 lie immediately inside the two screens 15 and the two columns 14 immediately outside them.

The modified array is utilised in the same way as the array of the indicator-apparatus 1 in that one row 13 of amber LEDs is energised to provide a horizontal datum-bar 16, and the green LEDs of the columns 12 below the bar 16 are energised to provide vertical alignment-bars 17. However, in this case the red LEDs of the columns 14 below the bar 16 are also energised to provide vertical warning-bars 18 one or the other of which is visible to the pilot only when the aircraft has deviated to the left or right of the center-line to the docking station.

While the aircraft is approaching the docking station on track, the two green bars 17 will be visible, but because of the baffle-screens 15, the red warning-bars 18 will be obscured from view unless there is deviation from the center-line. If in this regard, the aircraft deviates to the left or right of the center-line, the pilot's line of sight will be changed from straight-on to an angled direction as, for example, represented in exaggerated form for deviation to the left, by the arrow A in FIG. 8. The consequence of this change for angular deviation to the left of 10 degrees or more from the center-line, is that the red bar 18 of the left-hand column 14 is visible with the green bar 17 of the right-hand column 12, whereas the green bar 17 of the left-hand column 12 is obscured by the left-hand screen 15; the action of the left-hand screen 15 in obscuring the left-hand column 12 from direction A is illustrated in FIG. 9.

The red bar 18 of the left-hand column 14 first becomes visible for deviation to the left of the center-line of 6 degrees or more, whereas the green bar 17 of left-hand column 12 is not obscured completely by the left-hand screen 15 until the deviation reaches 10 degrees. Accordingly, for deviations to the left between 6 degrees and 10 degrees, the left-hand green and red bars 17 and 18 are visible together side-by-side along with the right-hand green bar 17.

The corresponding situation applies for deviations to the right of the center-line, in that the right-hand red bar 18 becomes visible for deviations of 6 degrees or more to the right of the center-line, and the right-hand green bar 17 is obscured by the right-hand screen 15 for deviations of 10 degrees or more.

1-20. (canceled)

21. A method for affording guidance in bringing an aircraft or other vehicle to a defined position in a docking station, wherein a horizontal indicator fixed relative to the docking station is viewed along an inclined line of sight from the vehicle against the background of a vertical array of a multiplicity of horizontal rows of light sources spaced at a distance behind the horizontal indicator, the light sources being energised selectively by row to emit light that defines a horizontal datum in the array, manoeuvre of the vehicle towards the docking station reducing visually the vertical separation between the horizontal indicator and the horizontal datum until they are visually aligned with one another when the vehicle is located in said defined position in the docking station.

22. The method according to claim 21, further comprising the step of aligning the array to comprise vertical columns and horizontal rows of light sources, and energizing the light sources of a horizontal row of the array to define the horizontal datum.

23. The method according to claim 21, further comprising the step of defining the horizontal indicator by energising light sources.

24. The method according to claim 22, further comprising the step of using light-emitting diodes as the light sources.

25. The method according to claim 21, further comprising the step of locating a vertical indicator with the horizontal indicator and the background includes a vertical datum, the method including viewing the vertical and horizontal indicators along the inclined line of sight against the vertical and horizontal datums of the background, manoeuvre of the vehicle towards and into an alignment with the docking station reducing visually both the vertical separation between the horizontal indicator and the horizontal datum as aforesaid, and the horizontal separation between the vertical indicator and the vertical datum.

26. The method according to claim 25, further comprising the step of defining the vertical indicator by energising light sources.

27. The method according to claim 26, further comprising the step of using light-emitting diodes as the light sources of the vertical indicator.

28. The method according to claim 25, further comprising the steps of forming the array to comprise an array of vertical columns and horizontal rows of light sources, and energizing at least some of the light sources of two spaced columns of the array to define the vertical datum.

29. The method according to claim 28, further comprising the step of forming the two columns within a pair of baffle-screens such that according to deviation of the vehicle to one side or the other out of the alignment with the docking station, one or other of the columns is obscured by the baffle-screens from view along the line of sight.

30. The method according to claim 29, further comprising the step of forming two further columns of the array which lie outside the pair of baffle-screens are obscured by the baffle-screens from view along the line of sight while the vehicle is in said alignment with the docking station, and one or the other of the two further columns come into view along the line of sight in dependence upon the extent of deviation of the vehicle to the left or right respectively from that alignment.

31. Apparatus for affording guidance in bringing an aircraft or other vehicle to a defined position in a docking station, comprising a horizontal indicator fixed relative to the docking station, a vertical array of a multiplicity of horizontal rows of light sources, the array being spaced at a distance behind the horizontal indicator, and means for energising the light sources selectively by row to emit light, the emitted light defining a horizontal datum in the array such that when the horizontal indicator is viewed along an inclined line of sight from the vehicle manoeuvre of the vehicle towards the docking station reduces visually the vertical separation between the horizontal indicator and the horizontal datum until they are visually aligned with one another when the vehicle is located in said defined position in the docking station.

32. The apparatus according to claim 31, wherein the array comprises an array of vertical columns and horizontal rows of light sources, and wherein the apparatus includes means for selecting a row of the array, and means for energising the light sources of the selected row to define the horizontal datum.

33. The apparatus according to claim 31, wherein the horizontal indicator is defined by light sources.

34. The apparatus according to claim 32, wherein the light sources are light-emitting diodes.

35. The apparatus according to claim 31, wherein a vertical indicator is located with the horizontal indicator and the array includes a vertical datum that is spaced at said distance behind the horizontal and vertical indicators such that when the vertical and horizontal indicators are viewed along the inclined line of sight against the vertical and horizontal datums, manoeuvre of the vehicle towards and in alignment with the docking station reduces visually both the vertical separation between the horizontal indicator and the horizontal datum as aforesaid, and the horizontal separation between the vertical indicator and the vertical datum.

36. The apparatus according to claim 35, wherein the vertical indicator is defined by light sources.

37. The apparatus according to claim 36, wherein the light sources of the vertical indicator are light-emitting diodes.

38. The apparatus according to claim 35 wherein the array comprises an array of vertical columns and horizontal rows of light sources, and wherein at least some of the light sources of two spaced columns of the array are energised to define the vertical datum.

39. The apparatus according to claim 38, wherein the two columns lie within a pair of baffle-screens such that according to deviation of the vehicle to one side or the other out of the alignment with the docking station, one or other of the columns is obscured by the baffle-screens from view along the line of sight.

40. The apparatus according to claim 39, wherein two further columns of the array lie outside the pair of baffle-screens to be obscured by the baffle-screens from view along the line of sight while the vehicle is in said alignment with the docking station, and one of the two further columns comes into view along the line of sight, the particular one of the two further columns that comes into view along the line of sight being dependent upon the extent and sense of deviation of the vehicle laterally from that alignment.
